(19) United States
(12) Patent Application Publication
(10) Pub. No.: US 2021/0015714 A1
(43) Pub. Date: Jan. 21, 2021

(54) TEETHING DEVICE FOR CHILDREN

(71) Applicant: Wendy Schmitz, Calhan, CO (US)

(72) Inventor: Wendy Schmitz, Calhan, CO (US)

(21) Appl. No.: 16/934,005

(22) Filed: Jul. 20, 2020

Related U.S. Application Data
(60) Provisional application No. 62/875,961, filed on Jul. 18, 2019.

(51) Int. Cl. A61J 17/02; A61J 17/00

(52) U.S. Cl. CPC A61J 17/02; A61J 17/113

(57) ABSTRACT

The present invention is directed to a teething device for children to alleviate the pain and discomfort associated with the emergence of teeth through their gums which typically occurs between month 4 and month 7 of a child's life. Various embodiments are described herein which surround the use of a mesh outer envelope filled with pellets contained therein.

### CROSS REFERENCE TO REFERENCE TO RELATED APPLICATIONS

This application is a claims the benefit of U.S. Provisional Patent Application 62/875,961 entitled “TEETHING DEVICE FOR CHILDREN” filed on Jul. 18, 2019 the entire contents of which are incorporated herein by reference in its entirety for all purposes.

### FIELD OF THE INVENTION

The present invention is directed to a teething device for children to alleviate the pain and discomfort associated with the emergence of teeth through their gums which typically occurs between month 4 and month 7 of a child's life.

### BACKGROUND OF THE INVENTION

During the early stages of life, children undergo many physical and physiological changes which are often unappreciated and unknown to adults as these experiences occur prior to the development which allows permanence of memory.

Amongst these changes, children undergo a process commonly referred to as teething which involves the emergence of the child's deciduous teeth—commonly referred to as “baby teeth,” “milk teeth,” “primary teeth,” or “temporary teeth.” For the purpose of the instant application, these deciduous teeth will be referred to as “baby teeth.” The process of teething extends from the initial emergence of the central incisors to the emergence of their second molars which occurs between 22 months and 33 months of age.

The emergence of baby teeth causes pain and discomfort, often severe enough to wake a baby from sleep. In the past, a number of strategies to alleviate these pains have been utilized including the use of chew toys, cold items, massaging a child's gums with a finger, or medication.

The American Academy of Pediatrics recommends the use of chew toys, cold things, and massaging actions to help alleviate a child's discomfort or pain associated with teething.

Although many baby teething soother products have been produced, marketed and created, there is a need for a product that provides a chew toy having massaging capabilities, provide the option of cold-therapy while remaining child-safe and hygienic.

### SUMMARY OF THE INVENTION

It is an aspect of certain embodiments of the present invention to provide a chew-toy having massaging functionality, cold-therapy capable, while remaining child-safe and hygienic.

Certain existing technologies, such as disclosed by U.S. Patent Publication No. 2013/0338711 to Strazzeri, which is incorporated in its entirety herein by reference for all purposes, provide soothing action using a plastic form filled with liquids to allow for freezing. The frozen liquids provide a soothing action to help alleviate pains and discomfort associated with teething. However, it has been stated by the American Academy of Pediatrics that these types of teething rings or liquid forms that are frozen solid are too hard for children's mouths and recommend against their use. It is an aspect of certain embodiments of the present invention to provide cooling action while providing a physical form having a malleable surface which are appropriate for children to chew on.

The American Academy of pediatrics goes on to suggest that a damp washcloth which has been twisted or knotted, then frozen for better gnawing and soothing action. However, once the cloth thaws, it gives little relief and results in the child being left wet and in need of a change of clothes.

It is an aspect of certain embodiments of the present invention to provide cooling action to a teething child through the use of a water absorbent material which can be frozen and used for gnawing on without resulting in excess water ending up on the child and soaking the child's clothing.

The American Academy of Pediatrics also indicates that massaging a child's gums with a clean finger particularly on sore portions of their gums. Unfortunately, a parent is typically unable to constantly massage their children's gums every instance that the child feels discomfort. For hygienic reasons it is recommended that a parent wash their hands prior to inserting their hands into their child's mouth. However, it is not far-fetched that a tired or hasty parent may forego or inadvertently forget the act of washing their hands for the immediate relief of a crying or screaming child. While other parents may choose to not massage a child's gums simply on the basis of their own personal hygiene.

It is an aspect of certain embodiments of the present invention to provide massaging action simply though the insertion and chewing by a child. Material of certain embodiments provides a malleable material such that it mimics the massaging action as may be provided by a finger of a caregiver. Certain embodiments utilize a malleable material such as silicone which is washable, and hygienic for a child to place in their mouths.

Some parents may find that topical pain relievers and numbing agents alleviate the pain in the sore or painful gums of their teething child. However, the American Academy of Pediatrics indicates that the use of medications is both potentially short-lived as well as potentially dangerous. A teething baby produces copious amounts of saliva, and thereby results in any medication being potentially washed away quickly and negating any potential benefits that may be found. Additionally, pediatricians warn that certain medications which numb the back of the child's throat, such as benzocaine, can pose a safety risk as they interfere with a child's ability to swallow.

It is an aspect of certain embodiments of the present invention to provide a device configured to occupy and provide relief to a child without the use of dangerous chemicals or medications which may cause safety risks to a child. Certain embodiments comprise an outer knit envelope comprising a chemically safe textile such as cotton or wool. Certain embodiments comprise a filling of chemically safe pellets, such as a silicone-based composition, which have been accepted as food-safe and chemically-safe materials which do not present toxicity or endocrine disruptor dangers. Endocrine disruptors are chemicals associated with interfering with endocrine (or hormone) systems at certain doses. These disruptions can cause cancerous tumors, birth defects, and other developmental disorders. Furthermore, endocrine disruptors may be associated with development of learning disabilities, severe attention deficit disorder, cognitive and brain development problems, congenital defects, breast cancer, prostate cancer, thyroid and other cancers and a number of other potential disorders and diseases.

Certain embodiments of the present invention combine the malleable form of a textile, such as cotton, in a mesh or knit closed form with a hollow internal aspect. The internal aspect of certain embodiments is filled with a pellets configured and chemically designed to provide a malleable massaging action while being chemically safe and hygienic.

Certain existing solutions for teething children include the use of teething bracelets or necklaces which comprise beads for a child to chew on. However, such solutions pose a choking risk if the child is left alone with such devices. Furthermore, the United States Food and Drug Administration warns parents against the use of such devices as the individual beads pose a choking hazard, particularly in the event they become separated from the device. (FDA News Release: “FDA warns about safety risks of teething necklaces, bracelets to relieve teething pain or to provide sensory stimulation” [Online] Food and Drug Administration, 2018 [Retrieved on May 23, 2019] Retrieved from internet: <URL: https://www.fda.gov/news-events/press-announcements/fda-warns-about-safety-risks-teething-necklaces-bracelets-relieve-teething-pain-or-provide-sensory>.

Certain existing teething devices, such as U.S. Design Pat. No. D541,355 to Strasbach, for children provide a hollow flexible device comprising a water proof structure with a single aperture allowing the device to be squeezed by a child wherein the aperture allows the alternative expulsion and suction of ambient air into and out of an inner cavity. Such devices often suck in not only air, but also moisture such as water and saliva from a child. Resultantly, such devices are increasingly known to grow and harbor mold and bacteria within, causing concern for the health of children.

It is an aspect of certain embodiments of the present invention to provide a device for the soothing of a teething child, while allowing the device to be cleaned periodically using conventional methods found in the home, including dishwashers, clothes washers, and handwashing. In certain embodiments, the pellets held within the outer envelope have a solid outer form and lack a cavity exposed to the ambient atmosphere, such as a thru-hole, which may retain moisture and provide a hospitable environment for bacteria or mold to grow.

It will be appreciated by those skilled in the art that objects which are small enough to pass through a child's open mouth while being large enough to restrict swallowing may pose a choking hazard.

It is an aspect of certain embodiments of the present invention to comprise a form which does not pose a choking hazard to a child. It will be appreciated that objects larger than 2 inches are unable to pass through a child's open mouth. Thus, certain embodiments comprise an outer envelope having a minimum dimension larger than 2 inches. Furthermore, certain embodiments comprise an outer envelope having a minimum dimension between 2 inches and 6 inches. Furthermore, the envelope of certain embodiments is of size and form such that portions of the outer envelope do not occlude a child's nasal passages or impede breathing when in use by the child.

It is an aspect of the present invention that the device allows for a child to chew on the device without discomfort associated with over exertion or hyper-extension of the jaw and associated muscles. Thus, certain embodiments comprise an outer envelope having fill pellets to less than 100% of the volumetric capacity of the outer envelope. It will be appreciated that volumetric capacity as discussed herein surrounds the maximum volume of the hollow outer envelope absent deformation of the outer envelope. By filling the outer envelope to less than 100% of capacity, this serves to allow the manipulation of the device within a child's mouth comfortably.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1A—Cross-sectional view of certain embodiments of the present invention

FIG. 1B—A detail view of mesh construction of certain embodiments of the present invention shown in FIG. 1A.

FIG. 2—A perspective view of certain embodiments of the present invention

FIG. 3A—A front view of certain embodiments of a spherical pellet of certain embodiments

FIG. 3B—A front view of certain embodiments of an ovoid pellet of certain embodiments

FIG. 3C—A front view of certain embodiments of a pyramidal pellet of certain embodiments

FIG. 3D—A front view of certain embodiments of a double-pyramidal pellet of certain embodiments

FIG. 3E—A front view of certain embodiments of a double-conical pellet of certain embodiments

FIG. 3F—A front view of certain embodiments of a double-frustum pellet of certain embodiments

### DETAILED DESCRIPTION OF VARIOUS EMBODIMENTS

Certain embodiments of the present invention comprise a teething device 1000. The teething device 1000 comprises a hollow outer envelope 1010 comprising mesh which surrounds an inner aspect 1030. The inner aspect 1030 is filled with pellets comprising a non-toxic material, such as silicone.

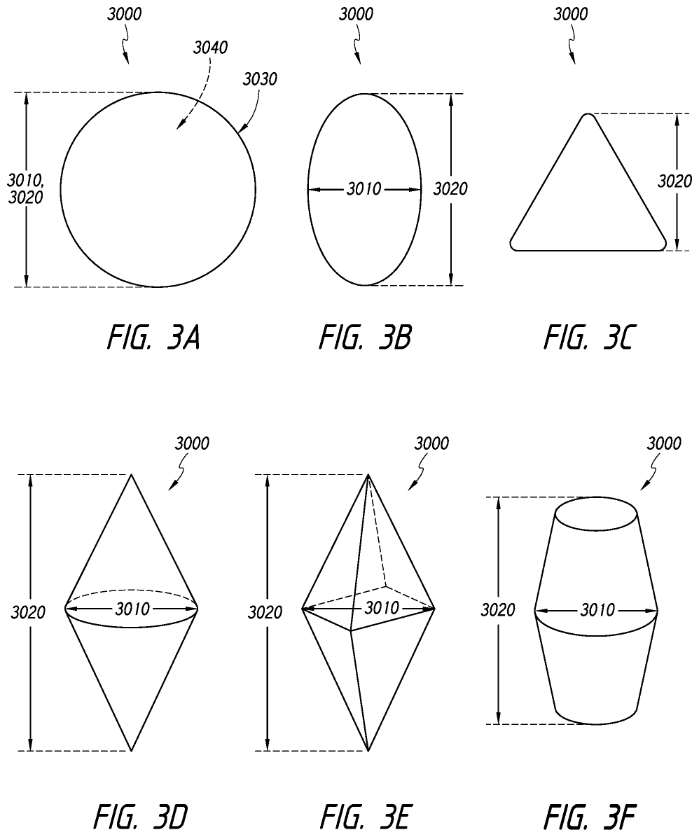

The outer envelope 1010 of certain embodiments comprises a mesh 1020 construction. A mesh 1020, as discussed herein includes knit, crocheted, or other methods of creating an area of fabric from textile yarns or filament appreciated by those skilled in the art. The mesh 1020 of certain embodiments is configured to retain pellets 1040 within the inner aspect of the outer envelope. Thus, the mesh 1020 of certain embodiments is desired to having openings 1050 having a maximum dimension 1060 which is less than a minimum dimension 3010 (FIG. 3A-FIG. 3F) of the pellets, thus preventing the pellets from passing through the openings 1050 of the mesh. The mesh of certain embodiments comprises cotton. Certain embodiments comprise a heavy weight cotton such as a 3-4 weight yarn, DK weight, worsted weight, or heavy worsted. The mesh can be constructed from alternative textiles or materials while in keeping with the spirit and scope of the present invention.

The outer envelope 1010 of certain embodiments comprises a form having a minimum dimension 2000 between 2 inches and 6 inches. A minimum dimension as discussed herein refers to the smallest linear dimension which can be measured across the center-point of a geometric object.

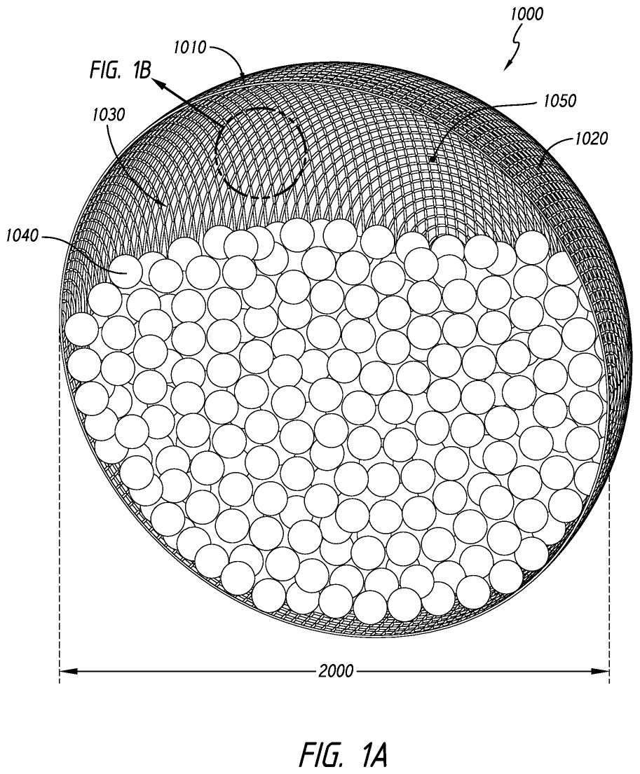

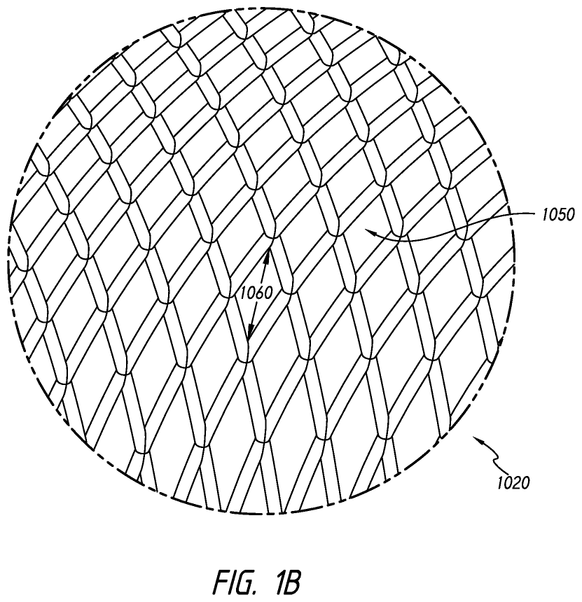

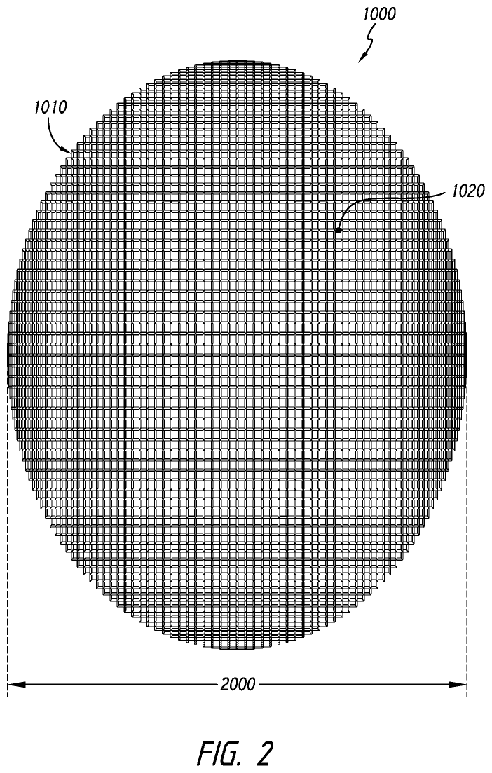

The outer envelope of certain embodiments may comprise shapes such as spherical (FIG. 1A), ovoid (FIG. 2), or other shapes while in keeping with the spirit and scope of the present invention. It will be further appreciated that certain embodiments of the present invention may embody shapes which are purely for the purpose of aesthetics while in keeping of the spirit and scope of the present invention.

The shape of such pellets 3000 of certain embodiments may comprise a variety of shapes including spherical (FIG. 3A), ovoid (FIG. 3B), pyramidal (FIG. 3C), double-pyramidal (FIG. 3D), double-conical (FIG. 3E), or double-frustum forms (FIG. 3F). It will be appreciated that a pyramid, as discussed in the context of this application, comprises a polyhedron of which one face, often considered a base, is a polygon of any number of sides, and the other faces are triangles with a common vertex. It will be further appreciated that a double-pyramidal comprises a first pyramid and a second pyramid, conjoined by their base. Similarly, a double-conical form comprises a first cone and a second cone conjoined by their bases. The pellets 3000 which fill the hollow outer envelope 1010 may comprise pellets 3000 of a single shape, while other embodiments comprise pellets of multiple shapes while in keeping with the spirit and scope of the present invention. It will be appreciated that pellets having a shape outside of embodiments described herein are in keeping with the spirit and scope of the present invention.

The pellets of certain embodiments comprise a maximum dimension 3020 less than 9 mm, while pellets of certain embodiments comprise a maximum dimension 3020 between 6 mm and 9 mm. It will be appreciated for the purposes of this application that a maximum dimension refers to the largest linear dimension which can be measured between any two points of an object.

The pellets 3000 of certain embodiments comprise a closed outer form wherein an internal aspect 3040 of the pellets is sealed from air or liquid communication with an external 3030 aspect of the pellet.

Certain embodiments of the present invention comprise an outer envelope 1010 having fill pellets 3000 occupying less than 100% of the volumetric capacity of the outer envelope. Certain embodiments comprise fill pellets 3000 occupying between 25% and 100% of the volumetric capacity of the inner aspect 1030 outer envelope.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A teething device for children comprising:
a flexible hollow outer envelope comprising a mesh structure;
an inner aspect of the outer envelope contains pellets therein, the pellets comprising a non-toxic material;
the mesh comprising openings having a maximum dimension less than a minimum dimension of the pellets.

2. The teething device of claim 1, wherein the flexible hollow outer envelope comprising a textile material.

3. The teething device of claim 2, wherein the textile material is selected from a list consisting of cotton, and wool.

4. The teething device of claim 1, wherein the outer envelope comprises an ovoid shape.

5. The teething device of claim 4, wherein the outer envelope has a minimum dimension between 2 inches and 6 inches; and
the openings of the mesh have a maximum dimension between 6 mm and 9 mm.

6. The teething device of claim 4, wherein the pellets comprise a silicone-based composition.

7. The teething device of claim 6, wherein the pellets comprise an outer form selected from a list consisting of ovoid, spherical, diamond, pyramidal, double-pyramidal, conical, double-conical, frustum, and double-frustum forms.

8. The teething device of claim 1, wherein the pellets comprise between 25% and 75% of a volumetric capacity of the outer envelope.

9. The teething device of claim 8, wherein the pellets comprise a silicone-based composition.

10. The teething device of claim 1, wherein the pellets comprise a silicone-based composition.

11. The teething device of claim 10, wherein the pellets comprise a closed outer form wherein an internal aspect of the pellets is sealed from air or liquid communication with an external aspect of the pellet.

12. The teething device of claim 10, wherein the pellets comprise an outer form selected from a list consisting of ovoid, spherical, diamond, pyramidal, double-pyramidal, conical, double-conical, frustum, and double-frustum forms.

13. The teething device of claim 12, wherein the pellets comprise a closed outer form wherein an internal aspect of the pellets is sealed from air or liquid communication with an external aspect of the pellet.

14. A teething device for children comprising:
a flexible hollow outer envelope comprising a cotton mesh structure, the outer envelope having a minimum dimension between 2 inches and 6 inches;
an inner aspect of the outer envelope comprising silicone-based pellets having a maximum dimension between 6 mm and 9 mm;
the pellets comprising a volume between 25% and 75% of a volumetric capacity of the outer envelope; and
the mesh comprising openings having a maximum dimension less than a minimum dimension of the pellets.

15. The teething device of claim 14, wherein the pellets comprise a closed outer form selected from a list consisting of: ovoid, spherical, diamond, pyramidal, double-pyramidal, conical, double-conical, frustum, and double-frustum forms.

16. The teething device of claim 15, wherein the pellets comprise a closed outer form wherein an internal aspect of the pellets is sealed from air or liquid communication with an external aspect of the pellet.
